(19) United States
(12) Patent Application Publication
(10) Pub. No.: US 2020/0018654 A1
(43) Pub. Date: Jan. 16, 2020

(54) PITOT TUBE HEAT ALARM

(71) Applicant: AIRR Engineering, LLC, Carrollton, TX (US)

(72) Inventors: Robert J. Seloff, Carrollton, TX (US); Douglas E. Jacobson, Vail, AZ (US); James Anthony Zollo, Prosper, TX (US)

(21) Appl. No.: 16/458,652

(22) Filed: Jul. 1, 2019

Related U.S. Application Data
(60) Provisional application No. 62/696,976, filed on Jul. 12, 2018.

(51) Int. Cl. G01K 1/02; G01P 5/16; G08B 21/18

(52) U.S. Cl. CPC G01K 1/024; G08B 21/182; G01P 5/16

(57) ABSTRACT

Embodiment of the present invention include a system to alert ground personnel to excessive temperatures of pitot tube sensors. The first end of an attachment arm includes an attachment, such as hook, clamp, annular, or other attachment with a temperature sensor secured to its interior. The second end of the attachment arm is joined to an alarm, the alarm including a controller and a notifier. The temperature sensor is in communication with the controller, providing temperature data. The controller is in communication with the notifier(s), issuing activation instructions to the notifier upon an out of threshold temperature condition.

### BACKGROUND

### Field of the Invention

The present invention relates to aviation, more particularly, to aviation maintenance.

### Description of the Related Art

Aircraft, ships, and other vessels are often equipped with one or more pitot tubes. The pitot tubes are measuring instruments which measure the fluid flow velocity by converting the kinetic energy in the fluid flow into potential energy. The sensors collect and transmit pressure signals to flight instruments in the aircraft that indicate aircraft operating parameters such as air speed, altitude, angle of attack, and other information. Atmospheric moisture can freeze in the precision openings of the pitot tubes and thereby render the pitot tubes and flight instruments non-functional. Pitot tube sensors therefore incorporate internal anti-icing heating devices to prevent moisture from freezing on or in the pitot tube.

### SUMMARY

Exemplary embodiments of a pitot tube heat alarm are directed to systems and processes for notification of excessive heat on a pitot tube on stationary vehicle. Systems for notification of excessive heat on a pitot tube include an attachment arm, at least one temperature sensor, and an alarm. A first end of the attachment arm includes an attachment operable to removably secure the pitot tube heat alarm to a pitot tube. The temperature sensor is operable to provide temperature data from direct contact with the pitot tube or in immediate proximity with the pitot tube. The alarm, operable to provide notification of out of threshold temperature values, is joined to a distal end of the attachment arm, includes a controller and a notifier. The temperature sensor is in communication with the controller, the temperature sensor providing temperature data to the controller, the controller processing the temperature data for out of threshold values. The controller issues activation instructions to the notifier upon an out of threshold temperature condition.

These and other features, aspects, and advantages of the invention will become better understood with reference to the following description, appended claims, and accompanying drawings.

### BRIEF DESCRIPTION OF THE DRAWINGS

FIG. 1 shows a side perspective view of an embodiment of the invention as it may exist in operation;

FIG. 2 shows a side view of an embodiment of the invention as it may exist in operation;

FIG. 3 shows a cutaway view of an embodiment of the invention;

FIG. 4 shows a cutaway view of an embodiment of the invention;

FIG. 5 shows a cutaway view of an embodiment of the invention;

FIG. 6 shows a block diagram view of an embodiment of the invention; and

FIG. 7 shows a flowchart of operation of an embodiment of the invention.

### DETAILED DESCRIPTION

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The heating device in the pitot tube is sufficient to prevent freezing at elevated altitudes and sub-freezing in-flight temperature conditions. On the ground, the heating devices are capable of producing excessive heat for atmospheric conditions. If the pitot tube anti-icing heat function is activated while the aircraft is parked on the ground, ground personnel can be injured, the pitot tube can become out of specification or damaged, and pitot tube connectors incorporated for maintenance test apparatus can be damaged.

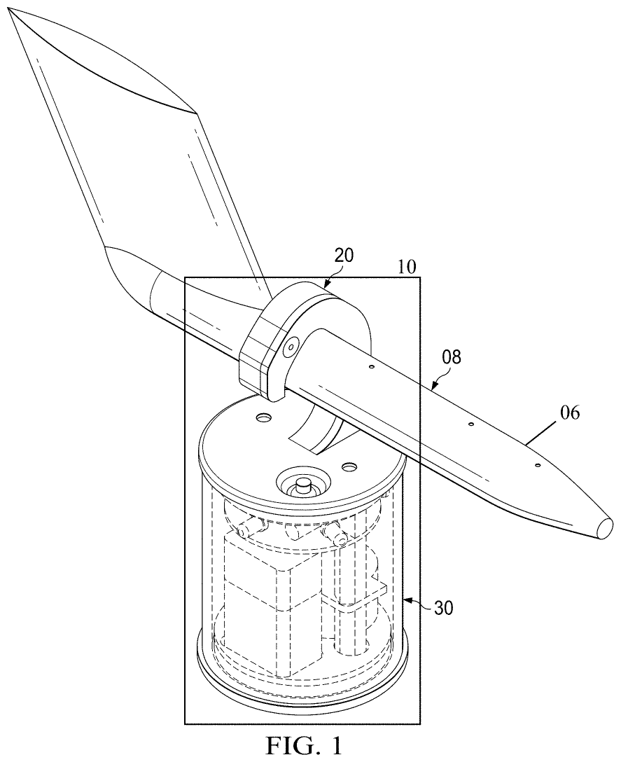

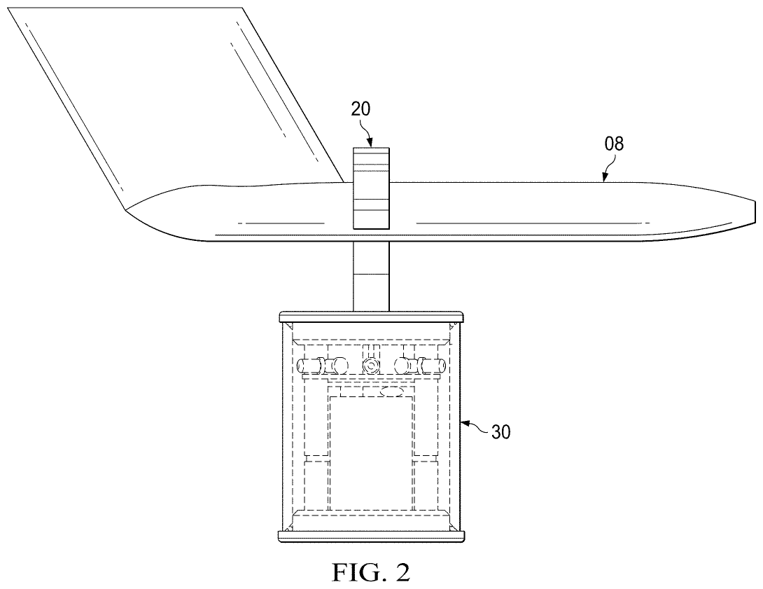

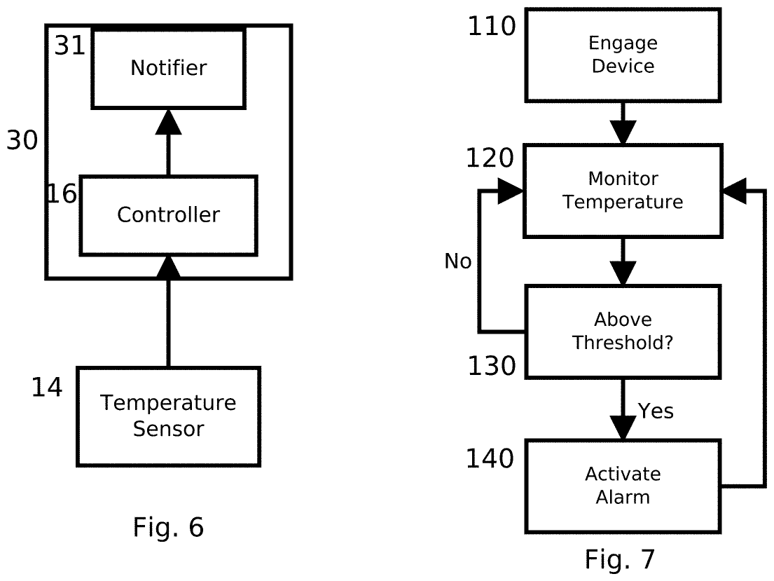

The present invention is directed to systems and processes for notification of excessive heat on a pitot tube 08, such as being activated while an aircraft is parked on the ground. Embodiments of the present invention notify personnel in the event of excessive heat to a pitot tube. FIGS. 1 and 2 illustrate an embodiment of a pitot tube heat alarm 10 as it may exist in operation and FIG. 6 illustrates a block diagram of major components of an embodiment of a pitot tube heat alarm 10. Exemplary embodiments of a pitot tube heat alarm 10 include an attachment arm 20, a temperature sensor 14, and an alarm 30.

A pitot tube heat alarm 10 is employed in order to provide notification of excessive heat on a pitot tube 08. Commonly, a pitot tube 08 includes a tube wall 06 and a heating element for generating heat for heating at least a portion of the tube wall 06 to prevent the pitot tube from becoming clogged with ice.

An exemplary attachment arm 20 is operable to removably secure the pitot tube heat alarm 10 to a pitot tube 08 while maintaining the temperature sensor 14 proximate the pitot tube 08 and the alarm 30 distal to the pitot tube 08. A first end of an attachment arm 20 includes an attachment.

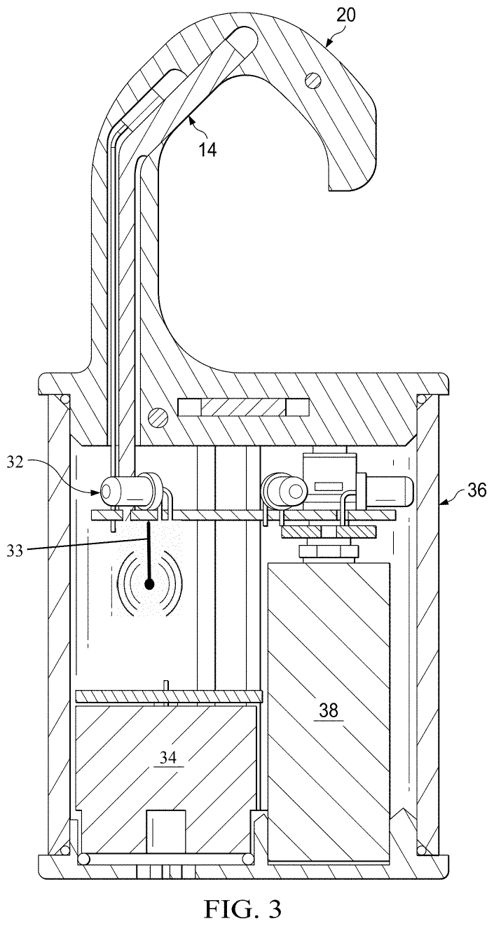

FIGS. 3-5 illustrate various representative attachments of different configurations of attachment arms 20. FIG. 3 illustrates an attachment arm 20 having a hook attachment. An exemplary hook attachment includes a rigid curvilinear section of material having interior and exterior, of a length to partial radially encompass a pitot tube wall 06, presenting a partial perimeter whereby an interior section may be engaged to a pitot tube wall 06. Further, in certain configurations, the degree of curvature is configured to support pitot tubes 08 of varying dimensions (e.g. width and perimeter).

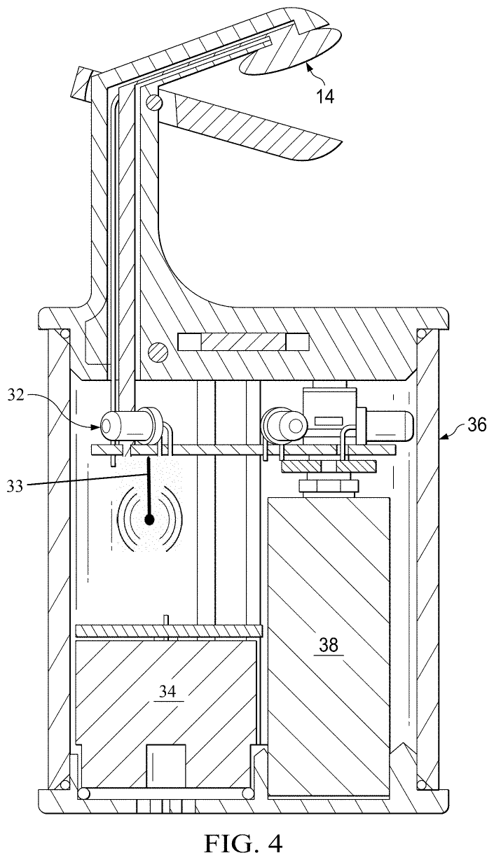

FIG. 4 illustrates an attachment arm 20 having a clamp attachment. An exemplary clamp attachment includes a pair of arms joined at and extending from a pivot to opposing ends with a force biasing the opposing ends toward each other, thereby presenting a region in which the pitot tube 08 can be secured.

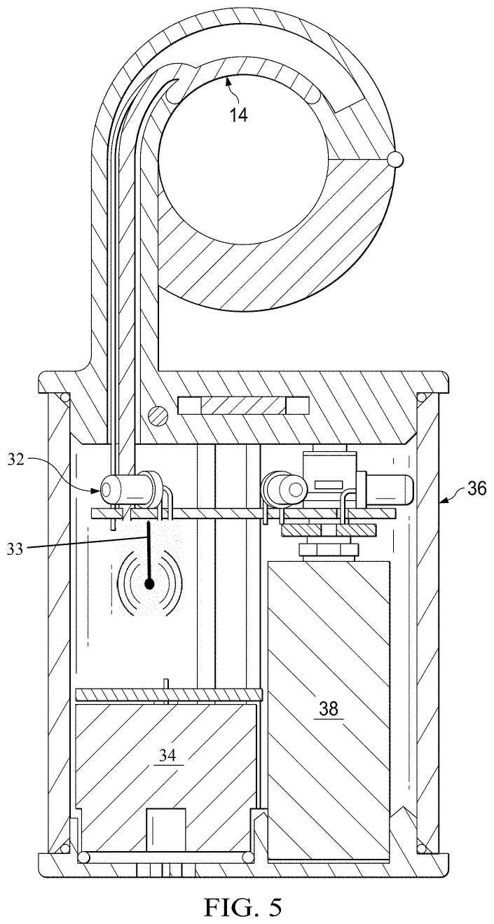

FIG. 5 illustrates an attachment arm 20 having an annular attachment. An exemplary annular attachment includes a ring section of material having interior and exterior, to radially encompass a pitot tube wall 06 or part thereof, presenting a perimeter whereby an interior section may be slidably engaged to a pitot tube wall 06. Further, in certain configurations, the degree of curvature is configured to support pitot tubes 08 of varying dimensions (e.g. width and perimeter).

Embodiments of the device 10 include one or more temperature sensors 14. In exemplary usage, the temperature sensor 14 is operable to provide temperature values from direct contact with the pitot tube 08 or immediate proximity with the pitot tube 08. Certain embodiments include a temperature sensor which can operate with or without power. Representative suitable temperature sensors 14 include resistance temperature detectors, thermistors, thermocouples, or other temperature sensors known in the art. In certain configurations, the temperature sensors 14 can operate in ranges of from about 0° to about 400°.

In exemplary configuration, the shape and dimensions of the temperature sensor 14 are configured for consistent and/or resilient placement relative to the pitot tube 08. In certain configurations, the temperature sensor 14 is fixably mounted on the interior section of the attachment. For example, in a hook attachment (FIG. 3) or an annular attachment (FIG. 5) configuration, the temperature sensor 14 may be disposed in the interior section of attachment, or more particularly the upper interior section, such that the weight of the alarm 30 depending from the consistently aligns the temperature sensor 14 with the pitot tube wall 06. For example, in a clamp attachment (FIG. 4), a temperature sensor 14 may be disposed toward the end of the attachment on the interior of an arm, such that the force bias of the clamp results in consistent alignment with the temperature sensor 14 and resilient engagement with the temperature sensor 14. In certain configurations, the dimensions of the temperature is configured for a target environment. For example, in an annular attachment (FIG. 5) configuration, the temperature sensor 14 can extend over different arcuate lengths of the interior of the attachment.

An exemplary alarm 30, operable to provide notification of out of threshold temperature values, includes a controller 16, a notifier 31, and a power source 38. The temperature sensor 14 is in communication with the controller 16, providing temperature data to the controller 16. The controller 16 processes the temperature data for out of threshold values. An out of threshold temperature value is one which is unlikely to occur while a pitot tube 08 is not actively being used on a vessel in transit, such as a parked aircraft or docked ship. In certain configurations, the threshold temperature is greater than common ambient temperature. In certain configurations, a threshold temperature of about 150° F. is employed. In certain configurations, a threshold temperature of about 400° F. is employed.

When an out of threshold temperature state occurs, the controller 16 triggers a notifier 31 in order to notify personnel of the condition. In certain configurations, the notifier 31 includes a light source 32. Exemplary lighting 32 is durable, impact resistant, energy-efficient, long-lasting, and luminous. Representative suitable lighting 32 includes LEDs, microLEDs, LED arrays, halogen bulbs, or other lighting known in the art. The lighting 32 can be single or multi-color, such as an RGB LED. The controller 16 can issue various controls signals to lighting 32 for sequences such as flashing, strobe, color sequences, or other sequences.

In certain configurations, the notifier 31 includes an audio source 34. An exemplary audio source 34 is durable, impact resistant, energy-efficient, long-lasting, and easily audible. Representative suitable audio sources 34 include speakers, horns, tweeters, buzzers or other audio sources known in the art. The audio can include tones, duty cycles, waveforms, words, phrases, or other audio signals. The controller 16 can issue various controls signals to lighting 32 for sequences such as varying tones, words, temperature reading, or other audio.

In certain configurations, the notifier 31 includes a transmitter 33. Representative suitable transmitter 33 include radio frequency or other transmitters known in the art. The transmission can include various modulation or protocols such as analog, digital, or other waveforms over various protocols such as frequency modulation, amplitude modulation, Bluetooth, 802.11, or other transmissions known in the art. The controller 16 can issue various controls signals to transmitter 33 with content such as analog audio, digital audio, digital encoded content, or other content for a receiver such as a radio or computer application for audio, visible, or automated by a person or computer.

Certain configurations of the pitot tube heat alarm 10 include housing 36, operable to contain elements of the pitot tube heat alarm 10 therein. The housing 36 presents a hollow interior and an exterior surface. Suitable housing is formed of durable and heat resistant material such as molded plastic or rubber or the like to support impact, durability, and protection of interior components. In certain configurations, the alarm 30 is disposed within the housing, with the controller 16 and notifier 31 housed therein. For example, a speaker 34 or LED array 32 may be housed therein. In certain configurations, the housing 36 is light transparent, such that light 32 can be transmitted therethrough.

Referring to FIGS. 1 and 6, the first end of an attachment arm 20 includes an attachment, such as hook, clamp, annular, or other attachment with a temperature sensor 14 secured to its interior. The second end of the attachment arm 20 is joined to an alarm 30, the alarm 30 including a controller 16 and a notifier 31. The temperature sensor 14 is in communication with the controller 16 over a wire or other connection, providing temperature data. The controller 16 is in communication with the notifier(s) 31 over a wire or other structure, transmitting control instructions, and issuing activation instruction to a notifier 31 upon an out of threshold temperature condition.

FIG. 7 illustrates representative operation of a pitot tube heat alarm 10. At step 110, a pitot tube heat alarm 10 is engaged to a pitot tube 08 to a stationary vehicle, such as a grounded aircraft. A hook clamp attachment arm 20 is placed on a pitot tube 08 with the temperature sensor 14 in contact with or immediate proximity to the pitot tube wall 06. At step 120, temperature sensor 14 output is continuously received by the controller 16. At step 130, the controller 16 processes the temperature sensor 14 value in order to determine whether the temperature is above threshold. At step 140, if the temperature is above threshold, the controller 16 issues control instructions to the notifiers 31, so that light notifier 32, transmitter notifier 33, and/or audio notifier 34 are activated, alerting personnel.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A system for notification of excessive heat on a pitot tube of a stationery vehicle, said system comprising:
an attachment arm, at least one temperature sensor, and an alarm;
a first end of said attachment arm comprising an attachment operable to removably secure said system to a pitot tube;
said temperature sensor operable to provide temperature data from direct contact with said pitot tube or immediate proximity with said pitot tube;
said alarm, operable to provide notification of out of threshold temperature values, joined to a distal end of said attachment arm, comprises a controller and a notifier;
said temperature sensor in communication with said controller, said temperature sensor providing temperature data to said controller, said controller processing said temperature data for out of threshold values; and
said controller issuing activation instructions to said notifier upon an out of threshold temperature condition.

2. The system of claim 1, further comprising a hook attachment, said hook attachment including a rigid curvilinear section presenting a partial perimeter for engagement to a pitot tube.

3. The system of claim 2, wherein said temperature sensor is fixably mounted on the interior section of said hook attachment.

4. The system of claim 1, further comprising a clamp attachment, said clamp attachment including a pair of arms joined at and extending from a pivot to opposing ends with a force biasing the opposing ends toward each other, presenting a region in which a pitot tube can be secured.

5. The system of claim 1, further comprising an annular attachment, said annular attachment including a ring section, presenting a perimeter for engagement to a pitot tube.

6. The system of claim 5, wherein said temperature sensor is fixably mounted on the interior section of said annular attachment.

7. The system of claim 1, wherein said notifier comprises a light source.

8. The system of claim 1, wherein said notifier comprises an audio source.

9. The system of claim 1, wherein said notifier comprises a radio frequency source.

10. The system of claim 1, further comprising transparent housing composed of durable and heat resistant material, said housing presenting a hollow interior, said alarm disposed within said housing.

11. A process for notification of excessive heat on a pitot tube, said process comprising the steps of:
(a) providing a system comprising an attachment arm, at least one temperature sensor, and an alarm;
a first end of said attachment arm comprising an attachment operable to removably secure said system to a pitot tube;
said temperature sensor operable to provide temperature data from direct contact with said pitot tube or immediate proximity with said pitot tube;
said alarm, operable to provide notification of out of threshold temperature values, joined to a distal end of said attachment arm, comprises a controller and a notifier;
said temperature sensor in communication with said controller, said temperature sensor providing temperature data to said controller, said controller processing said temperature data for out of threshold values; and
said controller issuing activation instructions to said notifier upon an out of threshold temperature condition; and
(b) engaging said system to a pitot tube of a stationery vehicle.

12. The process of claim 11, further comprising a hook attachment, said hook attachment including a rigid curvilinear section presenting a partial perimeter for engagement to a pitot tube.

13. The process of claim 12, wherein said temperature sensor is fixably mounted on the interior section of said hook attachment.

14. The process of claim 11, further comprising a clamp attachment, said clamp attachment including a pair of arms joined at and extending from a pivot to opposing ends with a force biasing the opposing ends toward each other, presenting a region in which a pitot tube can be secured.

15. The process of claim 11, further comprising an annular attachment, said annular attachment including a ring section, presenting a perimeter for engagement to a pitot tube.

16. The process of claim 15, wherein said temperature sensor is fixably mounted on the interior section of said annular attachment.

17. The process of claim 11, wherein said notifier comprises a light source.

18. The process of claim 11, wherein said notifier comprises an audio source.

19. The process of claim 11, wherein said notifier comprises a radio frequency source.

20. The process of claim 11, further comprising transparent housing composed of durable and heat resistant material, said housing presenting a hollow interior, said alarm disposed within said housing.
